(19) United States
(12) Patent Application Publication
(10) Pub. No.: US 2019/0037904 A1
(43) Pub. Date: Feb. 7, 2019

(54) FOOD-BASED PROTEIN FORMULATION

(71) Applicants: Sean R. Daly, Cincinnati, OH (US); Jonathan R. Thompson, Cincinnati, OH (US); Andrée K. Armand, Venice, CA (US)

(72) Inventors: Sean R. Daly, Cincinnati, OH (US); Jonathan R. Thompson, Cincinnati, OH (US); Andrée K. Armand, Venice, CA (US)

(21) Appl. No.: 16/054,194

(22) Filed: Aug. 3, 2018

Related U.S. Application Data
(60) Provisional application No. 62/541,342, filed on Aug. 4, 2017.

(51) Int. Cl. A23L 33/00; A23L 33/18; A23L 19/00; A23L 29/281

(52) U.S. Cl. CPC A23L 33/40; A23L 33/18; A23L 19/09; A23L 29/284; A23V 2002/00; A23V 2250/204; A23V 2250/54252; A23V 2250/5422; A23V 2250/5432; A23V 2250/156; A23V 2250/70

(57) ABSTRACT

A food-based protein formulation includes a puree of one or more fruits and/or vegetables and protein. The source of the protein may be plant-based or animal based. Exemplary sources include whey protein and hydrolyzed collagen. The formulation may be packaged in 160 calorie servings.

### CROSS-REFERENCE TO RELATED TO APPLICATION

This application claims the benefit of U.S. Provisional Application No. 62/541,342, filed Aug. 4, 2017, the contents of which are incorporated herein by reference in their entirety.

### FIELD

The present invention relates to food-based protein formulations, and more particularly, to food-based protein formulations for use as meal replacements or other purposes.

### BACKGROUND

Patients who undergo bariatric surgery and supervised medical weight loss for treatment of obesity are often ordered onto a highly restrictive diet. Typically, such a diet consists of eating no more than 160 calories every 3 waking hours. Patient compliance with these diets is limited because food enabling compliance with the diet is often not readily available and is typically not as appetizing as the normal food consumed by the patient before treatment. Indeed, most food marketed for bariatric surgery patients is in the form of mixable powders, flavored to mimic sweet foods while using no real foods, and are required to be mixed in a shaker bottle or blender before being consumed. These flavored powders can then cause the patients to crave sweet and other non-wholesome foods.

Spouted pouches, sometimes also called flexible fitment pouches, typically have a maximum volume of about 5 ounces. Due to this limited volume, food products in spouted pouches have been mostly marketed for toddlers and children, but they may also be marketed to adults as healthy snacks or protein supplements.

### SUMMARY

According to one aspect of the present invention, there is provided a food-based protein formulation including a puree of one or more fruits and/or vegetables and protein.

According to an aspect of the present invention, there is provided a food-based protein formulation including a puree of one or more fruits and/or vegetables and protein packaged in a flexible fitment pouch.

According to an aspect of the present invention, there is provided a food-based protein formulation packaged such that the packaged food-based protein formulation provides at least 160 calories, at least 20 g of protein, and at least 20% of a recommended daily value of vitamins and minerals for an adult person, as recommended by the U.S. Food & Drug Administration. The recommended daily value is understood to mean both current recommendations, available at https://www.accessdata.fda.gov/scripts/InteractiveNutritionFactsLabel/factsheets/Vitamin_and_Mineral_Chart.pdf (last accessed Jul. 3, 2018), the entire contents of which are incorporated by reference herein, and any future recommended values. The recommendations for calories and protein intake may be found at https://health.gov/dietaryguidelines/2015/guidelines/ (last accessed Jul. 3, 2018), the entire contents of which are incorporated by reference herein.

One advantage of the present invention is that a one-day supply of the food-based protein formulation, such as 5 of the flexible fitment pouches, can be packaged together for simple distribution to consumers.

A further advantage of the present invention is that the food-based protein formulation is shelf stable, does not require refrigeration, is ready to eat, and does not require mixing.

A further advantage of the present invention is that the food-based protein formulation encourages user compliance with restrictive diets by being convenient to carry and consume, and being pleasant tasting.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

A food-based protein formulation includes a puree of one or more fruits and/or vegetables, and protein. The one or more fruits and/or vegetables may comprise 30% to 60%, by weight, of the total formulation. The protein may comprise 10% to 25%, by weight, of the total formulation.

The fruits and/or vegetables are not particularly limited and may include both organic foods, as certified by a regulatory body such as the USDA, and non-organic foods. Possible fruits may include pears, apples, bananas, melons, apricots, peaches, plums, figs, dates, grapes, pineapples, oranges, grapefruit, lemons, limes, kiwi fruit, raspberries, strawberries, blueberries, and mangos. Possible vegetables include not only taxonomic vegetables, such as edible roots, but also those plants and plant products typically used as vegetables in food production. For instance, possible vegetables include squashes, tomatoes, potatoes, ginger, carrots, avocadoes, broccoli, lettuces of all varieties, cauliflower, beans and legumes, peppers, pumpkin, spinach, kale, parsnips, beets, fennel, turnips, cabbage, and sweet potatoes.

At least some embodiments of the food-based protein formulation are intended to be sold and/or used as meal replacements. Therefore, a relatively high content of protein may be needed in the formulation, such as between about 10% to about 25% by weight. Possible sources of protein include whey, hydrolyzed collagen, hemp, soy, peas, lentils, black beans, lima beans, peanuts, rice, chickpeas, almonds, chia seeds, oats, cashews, pumpkin seeds, potatoes, spinach, corn, avocadoes, broccoli, Brussels sprouts, asparagus, black-eyed peas, kale, quinoa, spirulina, sunflower seeds, pulses, algae, and ancient grains. In addition, the source of protein may be animal-based, such as one or more of insects, beef, pork, chicken, turkey, and fish. A convenient source of insect-based protein is crickets.

In one embodiment the protein is a blend or mixture of globular proteins, such as whey protein, and hydrolyzed collagen or hydrolyzed gelatin. An advantage of using hydrolyzed collagen or hydrolyzed gelatin is that neither requires additional water to remain fluidized, meaning that the formulation will not cause excessive thirst or dehydration in the user. But to achieve high protein density, whey protein may be advantageous. Whey protein is a protein-dense food source and is easily digested. Furthermore, whey protein may provide a velvety texture and good mouth feel when compared to a formulation using only hydrolyzed collagen or hydrolyzed gelatin. However too much whey protein can result in a bulky, brick-like texture in the formulation. The use of hydrolyzed collagen in combination with the whey protein provides a better texture and consistency to the formulation but retains many of the benefits of whey protein noted above. The ratio of whey protein to hydrolyzed collagen by weight can be, in one case 60/40, or 40/60 in another case, and all ratios therebetween, or in one case 70/30, or 30/70 in another case, and all ratios therebetween.

The food-based protein formulation may optionally include other ingredients, such as anti-caking agents, antioxidants, sweeteners (artificial or otherwise), emulsifiers, pH adjusters, coloring agents, humectants, flavorings, flavor enhancers, foaming agents, mineral salts, preservatives, thickeners and vegetable gums, stabilizers and firming agents, glazing agents, gelling agents, raising agents, caffeine, and bulking agents. Representative compositions belonging to these categories are known to those of ordinary skill and will not be discussed further herein. These optional other ingredients may comprise from 0% to 15%, by weight, of the total formulation.

The food-based protein formulation may include added water. This water may be filtered water, mineral water, deionized water, and/or water purified by reverse osmosis.

The food-based protein formulation can be packaged in a closed, sealed, fluid-tight package such that the formulation in the package has a predetermined amount of calories. For instance, the food-based protein formulation may be packaged in a flexible fitment pouch having a volume of less than about 10 fluid ounces (about 5 fluid ounces, or less, in one case) such that 4.5 ounces of the food-based protein formulation are stored therein, and the formulation provides at least 160 calories, at least 20 g of protein, and at least 20% of a recommended daily value of vitamins and minerals, as recommended by the U.S. Food & Drug Administration. Of course, other caloric values, protein amounts, nutritional values and pouch sizes could be used. In addition, the formulation can be stored in various other packages besides flexible fitment pouches, such as bottles or other containers with removable caps, tearable pouches, cans, etc.

Packaging the food-based protein formulation may involve in one case either an aseptic packaging process or a retort packaging process. The ingredients to be included in the formulation are mixed and/or blended to a generally uniform consistency. In an aseptic packaging process, sometimes also called a hot fill process, the food-based protein formulation is rapidly heated sufficient to sterilize the formulation, and then rapidly cooled, thereby limiting stress on the final product. The now sterilized food is then added to pre-sterilized containers, which are then sealed in a sterile environment. In the retort packaging process, the food-based protein formulation is added to a container, which is then sealed. The container and food are rapidly heated to sterilize both the container and its contents.

Conveniently, a one day's supply of these flexible fitment pouches could be packaged together to be sold as a single unit, where the unit supplies at least about 90% in one case, or at least about 100% in another case, of a recommended daily value of vitamins and minerals, as recommended by the U.S. Food & Drug Administration. Thus, at each time at which the patient is supposed to consume food, the patient could remove one pouch from the unit until all of the day's pouches are consumed. For instance, 5 of the 5 ounce pouches can be sold together, with the patient directed to consume one pouch every 3 hours that the patient is awake. In this way, the strictly regulated diet of the patient may be maintained.

### EXAMPLE

An exemplary formulation is as follows:

| Ingredient | Amount per serving (g) | % Weight |
|---|---|---|
| Water | 43.000 | 32.090 |
| Pectin | 0.350 | 0.261 |
| Whey protein isolate | 11.950 | 8.918 |
| Collagen hydrolysate | 7.950 | 5.933 |
| Phosphoric acid | 0.820 | 0.612 |
| Sodium Acid Sulfate | 0.360 | 0.269 |
| Malic acid | 0.520 | 0.388 |
| Pear juice concentrate | 7.000 | 5.224 |
| Butternut Squash Puree | 51.105 | 38.138 |
| Ginger Puree | 1.000 | 0.746 |
| Coconut Milk Powder | 5.140 | 3.836 |
| Coconut oil | 1.300 | 0.970 |
| Sunflower lecithin | 0.500 | 0.373 |
| Potassium Citrate | 0.300 | 0.224 |
| Potassium chloride | 0.595 | 0.444 |
| Magnesium phosphate | 0.370 | 0.276 |
| Calcium carbonate | 0.600 | 0.448 |
| 20% vitamin mineral blend | 0.320 | 0.239 |
| Stevia Reb A | 0.070 | 0.052 |
| Natural Flavors | 0.750 | 0.559 |

The formulation can include at least any two of the ingredients above or below, provided that one of the ingredients is a protein and the other includes a fruit or vegetable. In one case, the amount per serving, % weight, and/or amount or percentage of 2 or more ingredients relative to each other, can vary by up to about 5% from that listed above, or up to about 10% in another case, or up to about 25% in yet another case. In the above exemplary formulation, alternative ingredients may be used, as listed below. The following list is intended to be exemplary, not exhaustive.

| Ingredient | Alternative Ingredient |
|---|---|
| Water | filtered, mineral, deionized, reverse |
| | osmosis |
| Pectin | other hydrocolloids/stabilizers/starches |
| | and hydrocolloid systems having mouth |
| | feel, viscosity building, or protein |
| | protecting effects |
| Whey protein isolate | protein derived from milk, acidified or |
| | not, any dairy proteins or derivatives |
| | thereof, soy and other proteins from plant |
| | sources including rice, pea, pulses, algae |
| Collagen hydrolysate | beef, pork, chicken or fish collagen, |
| | hydrolyzed gelatin from same sources |
| Phosphoric acid | citric acid, lactic acid, fumaric acid, |
| | vinegar |
| Sodium Acid Sulfate | citric acid, lactic acid, fumaric acid, |
| | vinegar |
| Malic acid | citric acid, lactic acid, fumaric acid, |
| | vinegar |
| Pear juice concentrate | any other concentrates or single strength |
| | juices derived from fruit or vegetables, |
| | agave, erythritol, dextrose, fructose, |
| | tagatose, allulose, isomaltullose, isomalt, |
| | maltitol, sugar (refined, raw, brown), |
| | molasses, honey, maple syrup, coconut |
| | sugar, high fructose corn syrup, syrup |
| | derived from seeds, grains including but |
| | not limited to oat, rice, barley, sorghum; |
| | maltodextrin, corn syrup or corn syrup |
| | solids |
| Coconut oil | other oils from grains, seeds and nuts |
| Sunflower lecithin | soy or egg lecithin, other emulsifiers |
| | including mono and diglycerides, |
| Potassium Citrate | potassium phosphate |
| Magnesium phosphate | magnesium oxide, hydroxide, sulfate |
| Calcium carbonate | calcium phosphate (mono, di- or tribasic), |
| | hydoxide, |
| 20% vitamin mineral blend | vitamin mineral fortification from 0 to |
| | 500% |
| Stevia Reb A | any natural or artificial high intensity |
| | sweeteners including sucralose, |
| | acesulfame potassium, neotame, |
| | saccharin, cyclamates, talin, monk fruit, |
| | stevia rebausides a, D, C, M and any |
| | other rebauside isolates |

The present invention has been described herein with regard to certain embodiments. However, it will be obvious to persons skilled in the art that a number of variations and modifications can be made without departing from the scope of the invention as described herein.

What is claimed is:

1. A food-based protein formulation comprising:
a puree of one or more fruits and/or vegetables;
globular proteins; and
hydrolyzed collagen or hydrolyzed gelatin.

2. The food-based protein formulation of claim 1, wherein the globular proteins are whey protein.

3. The food-based protein formulation of claim 1, wherein the food-based protein formulation is packaged such that the packaged food-based protein formulation provides at least 160 calories, at least 20 g of protein, and at least 20% of a recommended daily value of vitamins and minerals, as recommended by the U.S. Food & Drug Administration.

4. The food-based protein formulation of claim 3, wherein the food-based protein formulation is packaged in a 5 fluid ounce flexible fitment pouch.

5. The food-based protein formulation of claim 4, wherein 4.5 fluid ounces of the food-based protein formulation is packaged in the 5 fluid ounce flexible fitment pouch.

6. The food-based protein formulation of claim 1, wherein the one or more fruits and/or vegetables are certified organic.

7. The food-based protein formulation of claim 1, wherein the globular proteins have a weight of between about 40% and about 60% as compared to the hydrolyzed collagen or hydrolyzed gelatin.

8. A food-based protein formulation comprising:
a puree of one or more fruits and/or vegetables; and
protein, wherein the puree and the protein are mixed and stored in a container having a volume of less than about 10 fluid ounces, and wherein the puree and the protein together provide at least 160 calories, at least 20 g of protein, and at least 20% of a recommended daily value of vitamins and minerals, as recommended by the U.S. Food & Drug Administration.

9. The food-based protein formulation of claim 8, wherein a source of protein is selected from the group consisting of hemp, soy, peas, lentils, black beans, lima beans, peanuts, rice, chickpeas, almonds, chia seeds, oat, cashews, pumpkin seeds, potatoes, spinach, corn, avocadoes, broccoli, Brussels sprouts, asparagus, black-eyed peas, kale, quinoa, spirulina, and sunflower seeds.

10. The food-based protein formulation of claim 8, wherein the protein is animal-based.

11. The food-based protein formulation of claim 10, wherein the source of protein is one or more insects.

12. The food-based protein formulation of claim 11, wherein the one or more insects comprise crickets.

13. The food-based protein formulation of claim 8, wherein the protein is globular proteins, and wherein the food-based protein formulation further includes hydrolyzed collagen or hydrolyzed gelatin, and wherein the globular proteins have a weight of between about 40% and about 60% as compared to the hydrolyzed collagen or hydrolyzed gelatin.

14. The food-based protein formulation of claim 13, wherein the globular proteins are whey protein.

15. A method for consuming a food-based protein formulation comprising:
accessing a food-based protein formulation including a puree of one or more fruits and/or vegetables, globular proteins, and hydrolyzed collagen or hydrolyzed gelatin; and
consuming said food-based protein formulation.

16. The method of claim 15, wherein the globular proteins are whey protein.

17. The method of claim 15, wherein the globular proteins have a weight of between about 40% and about 60% as compared to the hydrolyzed collagen or hydrolyzed gelatin.

18. The method of claim 17, wherein the globular proteins are whey protein.

19. The method of claim 15, wherein the puree, the globular proteins, and the hydrolyzed collagen or hydrolyzed gelatin, are mixed and stored in a container having a volume of less than about 10 fluid ounces, and wherein the puree, the globular proteins, and the hydrolyzed collagen or hydrolyzed gelatin, together provide at least 160 calories, at least 20 g of protein, and at least 20% of a recommended daily value of vitamins and minerals, as recommended by the U.S. Food & Drug Administration.

20. The method of claim 19, wherein the globular proteins are whey protein.
